(19) United States
(12) Patent Application Publication
(10) Pub. No.: US 2025/0244223 A1
(43) Pub. Date: Jul. 31, 2025

(54) METER WITH BUILT-IN FIRE DETECTION DEVICE

(71) Applicant: SAGEMCOM ENERGY & TELECOM SAS, BOIS-COLOMBES (FR)

(72) Inventors: Henri TEBOULLE, BOIS-COLOMBES (FR); Christophe GRINCOURT, BOIS-COLOMBES (FR)

(21) Appl. No.: 19/038,958

(22) Filed: Jan. 28, 2025

(30) Foreign Application Priority Data
Jan. 31, 2024 (FR) FR2400948

(51) Int. Cl. G01N 15/075; G01K 3/00; G01N 15/00

(52) U.S. Cl. CPC G01N 15/075; G01K 3/005; G01N 2015/0046

(57) ABSTRACT

An electricity meter includes a casing including a main part and a secondary part which is provided with at least one first opening, a smoke detection device positioned in the secondary part of the casing and arranged to detect smoke particles that have come from outside the meter and entered the secondary part through the at least one first opening and a processing unit positioned in the main part of the casing, connected to the smoke detection device and arranged to detect a fire occurring outside the meter if smoke particles are present in the secondary part of the casing.

The invention relates to the field of electricity meters.

### BACKGROUND

It is possible, albeit extremely unlikely, that incorrectly installing an electricity meter will cause a fire.

When installers connect the electrical supply cables to the meter terminal block, they position the conductors in the power terminals and then tighten them mechanically. However, if they do not tighten one of the cables enough, a resistance is created in the region of the terminal in question. This resistance can cause heating which can, on very rare occasions, cause a flame to appear, sparking a fire. It is therefore not the meter itself that has caused the fire but said incorrect installation.

In the event that a fire occurs in the room in which the electricity meter is located, it would be very beneficial for the meter to able to detect the fire and generate an alarm message. This makes it possible to quickly take measures to limit the impact of the fire. It would also be very beneficial to be able to determine with certainty whether the electricity meter (or rather its installation) is causing this fire or whether the fire has been caused by something else.

The aim is to implement this dual detection function (detecting both the fire and the cause of the fire) in a meter simply and inexpensively so as not to increase the development and manufacturing costs of the meter.

### OBJECT

The object of the invention is:
to detect the occurrence of a fire in a room in which an electricity meter is located;
to determine whether or not the meter is the cause of the fire;
and to do so simply and inexpensively.

### SUMMARY

To achieve this object, an electricity meter is proposed, comprising:
a casing comprising a main part and a secondary part which is provided with at least one first opening;
a smoke detection device positioned in the secondary part of the casing and arranged to detect smoke particles that have come from outside the meter and entered the secondary part through the at least one first opening;
a processing unit positioned in the main part of the casing, connected to the smoke detection device and arranged to detect a fire occurring outside the meter if smoke particles are present in the secondary part of the casing.

Owing to the smoke detection device, therefore, not only can the meter detect a fire but it can also provide conclusive proof that it (or its installation) is not the cause of the fire.

The smoke detection device is very simple and very inexpensive to implement.

In addition, an electricity meter as described above is proposed, the secondary part of the casing being located in a lower portion of the meter.

In addition, an electricity meter as described above is proposed, comprising a partition separating the main part and the secondary part of the casing, the at least one first opening being positioned in the region of a lower portion of the secondary part of the casing, the casing further comprising at least one second opening formed in the partition.

In addition, an electricity meter as described above is proposed, wherein the processing unit and the smoke detection device are mounted on the same printed circuit, which extends in the main part and the secondary part of the casing.

In addition, an electricity meter as described above is proposed, wherein the smoke detection device comprises a light emitter, arranged to emit light signals, and a light receiver, which are positioned in the secondary part of the casing such that:
when the secondary part does not contain smoke particles, the light receiver does not detect the light signals emitted by the light emitter;
when the secondary part contains smoke particles, the light signals emitted by the light emitter are at least partly reflected by said smoke particles and detected by the light receiver.

In addition, an electricity meter as described above is proposed, wherein a temperature sensor is also included, the processing unit being arranged to evaluate an ambient temperature outside the meter from temperature measurements produced by the temperature sensor, the processing unit being arranged to detect a fire occurring outside the meter:
if smoke particles are present in the secondary part of the casing;
and/or if the ambient temperature is above a predefined threshold.

In addition, an electricity meter as described above is proposed, the processing unit being arranged to evaluate the ambient temperature from the temperature measurements and from measurements of a current supplied to an installation, the electrical energy consumption of which is measured by the electricity meter.

In addition, a method for detecting a fire and a cause of the fire is proposed, said method being carried out in the processing unit of the meter as described above and comprising the step of detecting a fire occurring outside the meter if smoke particles are present in the secondary part of the casing.

In addition, a method as described above is proposed, said method being carried out in the processing unit of the meter as described above and further comprising the steps of:
evaluating the ambient temperature outside the meter;
detecting a fire occurring outside the meter if smoke particles are present in the secondary part of the casing and/or if the ambient temperature is above a predefined threshold.

In addition, a computer program is proposed, comprising instructions which cause the processing unit of the meter as described above to execute the steps of the method for detecting a fire and the cause of the fire as described above.

In addition, a computer-readable storage medium is proposed, on which the computer program as described above is stored.

The invention will be better understood in the light of the following description of a particular, non-limiting embodiment of the invention.

### BRIEF DESCRIPTION OF THE DRAWINGS

Reference will be made to the accompanying drawings, in which:

FIG. 1 is a perspective view of the electricity meter and its cover;

FIG. 2 is a simplified sectional view of the electricity meter along a plane parallel to the front face of the meter;

FIG. 3 is a simplified diagram of the meter.

### DETAILED DESCRIPTION

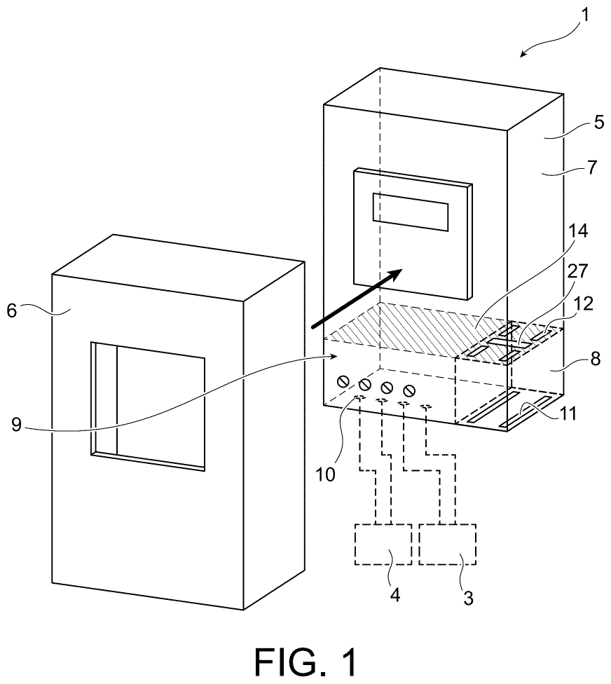

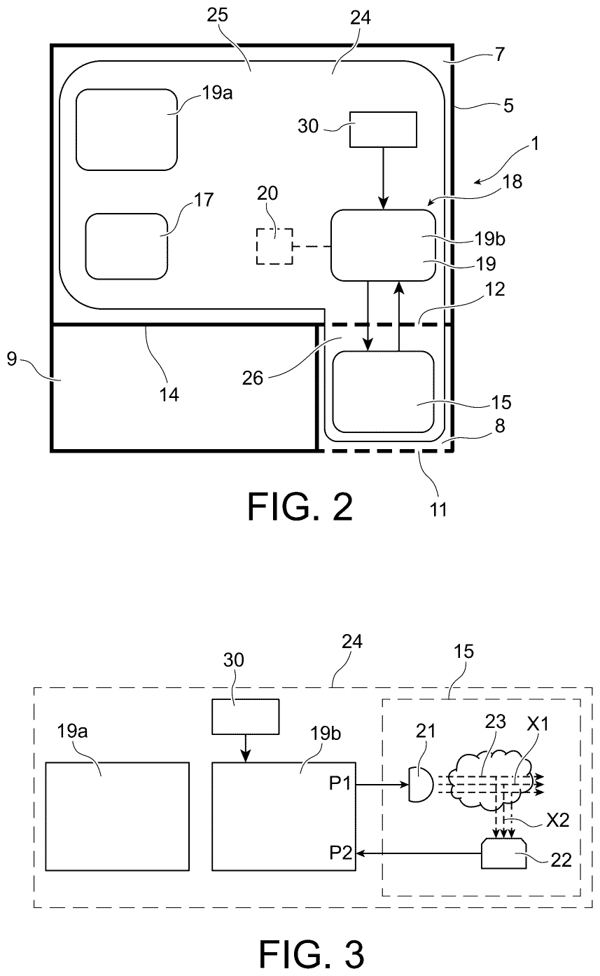

With reference to FIGS. 1 to 3, the electricity meter 1 is intended for measuring the electrical energy consumption of an installation 3 and for transmitting the measurements to the information system (IS) of the electricity supplier. This electrical energy is supplied to the installation 3 by a distribution network 4. In this case, the meter 1 is a single-phase meter, but it could also be a multi-phase meter.

The meter 1 is installed in a room by being positioned against a wall of said room and attached to the wall.

The meter 1 comprises a casing 5 and a removable cover 6 (both made of plastics material, for example). The casing 5 comprises a rear face which is also the rear face of the meter 1 and which is intended to be placed against the wall and attached to the wall. The cover 6 comprises a face which is also the front face of the meter 1 and which the customer or an operator can see and access.

In this case, all the positional terms (front, rear, upper, lower, top, bottom, etc.) should be interpreted while considering the meter 1 installed in its nominal operating position (with its rear face attached to a vertical surface).

The casing 5 is in one piece. It comprises a main part 7, which defines a main volume inside the casing 5, a secondary part 8, which defines a secondary volume inside the casing 5, and a terminal block 9.

The secondary part 8 and the terminal block 9 are located under the main part 7, that is to say, the main part 7 is located in an upper portion of the meter 1, and the secondary part 8 and the terminal block 9 are located in a lower portion of the meter 1.

Here, the secondary part 8 and the terminal block 9 are located next to each other, at about the same height.

The main part 7 contains most of the electrical and electronic components of the meter 1.

The terminal block 9 can be accessed by removing the cover 6 (as well as another locked and sealed cover; not shown) and comprises power terminals 10 to which the electrical supply cables (connected to the network 4) and the cables connected to the installation 3 are connected.

The secondary part 8 is in the shape of a parallelepiped and comprises at least one opening, advantageously at least one first opening 11 (in this case a plurality of first openings) and at least one second opening 12 (in this case a plurality of second openings).

The first openings 11 are positioned in the region of a lower portion of the secondary part 8 of the casing 5. Here, the first openings 11 are formed in an underside of the casing 5. The second openings 12 are formed in a separating partition 14 (here a horizontal partition) that separates the main part 7 and the secondary part 8 of the casing 5. The first openings 11 form an air inlet through which air can enter the secondary part 8 of the casing 5. The second openings 12 form an air outlet through which air can leave the secondary part 8 of the casing.

The first openings 11 and the second openings 12 give the secondary part 8 of the casing 5 a cage-like shape.

The air inlet and the air outlet create air circulation. Thus, when smoke is present in the room outside the meter 1, in the surroundings of the meter 1, this smoke rushes into the secondary part 8 via the air inlet and is trapped in said secondary part. Said cage includes a smoke detection device 15.

The separating partition 14 therefore prevents smoke from entering the main part 7 of the casing 5 in considerable volumes but still allows it to enter from the bottom to a limited extent.

This separating partition 14 is important because the main part 7 of the meter 1 has to be protected from smoke and various impurities. The protection has to comply with IP51 requirements if the meter 1 is intended to be installed indoors, and with IP54 if the meter 1 is intended to be installed outdoors. On the other hand, the region around the terminal block 9 at the bottom of the meter 1, where the secondary part 8 is also located, need only be IP2x-compliant, which is much less restrictive and in particular allows for considerable volumes of smoke being present. Next, the electrical and electronic components of the meter will be discussed.

The meter 1 comprises sensors (not shown) for measuring the electrical energy consumed by the installation 3. These sensors measure in particular the current flowing through the meter 1 (supplied by the network 4 to the installation 3) and the voltage applied by the network 4 at the input of the installation 3 (and the meter 1).

The meter 1 also comprises a cut-off member 17 which is intended to selectively cut off the current supplied to the installation 3. The cut-off member 17 comprises a switch for each phase of the distribution network 4 (a single switch in this case).

The meter 1 further comprises a processing unit 18 (electronic and software). The processing unit 18 comprises at least one processing component 19, which is, for example, a “general-purpose” processor, a processor specialising in signal processing (digital signal processor (DSP)), a microcontroller, or a programmable logic circuit, such as an FPGA (field-programmable gate array) or an ASIC (application-specific integrated circuit). The processing unit 18 also comprises one or more memories 20 connected to or integrated in the processing component. At least one of these memories 20 forms a computer-readable storage medium on which at least one computer program is stored, said computer program comprising instructions which cause the processing unit 18 to execute the steps of the method for detecting a fire and its cause, which will be described later.

In this case, the processing unit 18 comprises a “metrology” microcontroller 19a, which in particular acquires the measurements taken by the sensors of the meter 1 and carries out certain processing operations on said measurements, and an “application” microcontroller 19b, which in particular controls the cut-off member 17. The method for detecting a fire and its cause is also carried out in the application microcontroller 19b.

The smoke detection device 15 makes it possible to detect whether or not smoke is present outside the meter 1.

The smoke detection device 15 comprises a light emitter, in this case a light-emitting diode (LED) 21, and a light receiver, in this case a photodiode 22. Here, the LED 21 generates infrared light (for example with a wavelength of 860 nm), which the photodiode 22 can detect when the light rays reach its sensitive cell.

The LED 21 emits light signals 23. The LED 21 and the photodiode 22 are positioned in the secondary part 8 of the casing 5 such that:
when the secondary part 8 does not contain smoke particles, the photodiode 22 does not detect the light signals 23 emitted by the LED 21;
when the secondary part 8 contains smoke particles, the light signals 23 emitted by the LED 21 are at least partly reflected by said smoke particles and detected by the photodiode 22.

In this case, the LED 21 and the photodiode 22 are positioned in the secondary part 8 of the casing 5 such that the LED 21 emits light signals 23 along a first axis X1, and the photodiode 22 optimally detects light signals impinging on its sensitive cell along a second axis X2 perpendicular to the first axis X1. Thus, when there are no smoke particles present in the secondary part 8, the photodiode 22 does not detect the light signals emitted by the LED 21. On the other hand, when smoke particles are present, some of the light signals emitted by the LED 21 are reflected by the smoke particles and reach the photodiode 22.

The photodiode 22 outputs a binary electrical signal.

When no smoke is present, this binary signal adopts a first value.

When the quantity of smoke particles present in the secondary part 8 exceeds a certain threshold, the binary electrical signal adopts a second value.

The application microcontroller 19b comprises a port P1 connected to the LED 21 and a port P2 connected to the photodiode 22. The microcontroller 19b regularly produces a voltage that it applies to the terminals of the LED 21 via the port P1 so that said LED emits light signals, and acquires via the port P2 the binary electrical signal produced by the photodiode 22 to detect whether or not smoke is present in the secondary part 8 of the casing 5 and therefore in the room.

The application microcontroller 19b thus detects a fire occurring outside the meter 1 if smoke particles are present in the secondary part 8 of the casing 5.

In this case, the electronic components of the processing unit 18, the cut-off member 17 and the components of the smoke detection device 15 are mounted on the same printed circuit 24, which is positioned in the casing 5 in parallel with the front face thereof.

The printed circuit 24 therefore comprises a main portion 25, on which in particular the metrology microcontroller 19a, the application microcontroller 19b and the cut-off member 17 are mounted, and a secondary portion 26, on which in particular the LED 21 and the photodiode 22 are mounted. The printed circuit is in one piece and is L-shaped in this case; the main portion of the printed circuit 24 is in the shape of a rectangle, and the secondary portion 26 of the printed circuit 24 is also in the shape of a rectangle but with smaller dimensions, having one side extending away from one side of the main portion.

The main portion 25 of the printed circuit 24 is positioned in the main part 7 of the casing 5, and the secondary portion 26 of the printed circuit 24 is positioned in the secondary part 8 of the casing 5.

The printed circuit 24 passes through the separating partition 14 via an opening 27 (visible in FIG. 1) provided for this purpose. The printed circuit 24 is directly in contact with the partition 14 in the region of this opening.

Advantageously, the meter 1 also uses temperature information provided by a temperature sensor included in the meter.

The temperature sensor in this case is an NTC (negative temperature coefficient) thermistor 30. The thermistor 30 is mounted on the printed circuit 24 and located at a non-hot point in the casing 5. It is therefore remote from the cut-off member 17. In this case, the thermistor 30 is located near a first corner of the main portion 25 of the printed circuit 24, and the cut-off member 17 is located near a second corner of the main portion 25 of the printed circuit 24, the first corner and the second corner being diagonally opposite.

This thermistor 30 can be used to evaluate the ambient temperature in the room outside the meter 1.

The temperature measured by the thermistor 30 is not directly the ambient temperature but a representation thereof. The difference between the temperature measured by the thermistor 30 and the ambient temperature is a function of the current I flowing through the meter 1 (and consumed by the installation 3) and therefore via the cut-off member 17. The current I causes internal heating in the meter 1, which will act, by diffusion, on the temperature measured by the thermistor 30, regardless of the ambient temperature.

The processing unit 18 is therefore arranged to evaluate the ambient temperature from the temperature measurements produced by the thermistor 30 and from measurements of the current supplied to the installation 3, the electrical energy consumption of which is measured by the electricity meter 1.

The temperature θ measured by the thermistor 30 is therefore a function of the ambient temperature Tamb (ambient around the meter 1 in its external surroundings in the room where it is located) and the value of the current I (which can typically range from 0 to 100 A and may be equal to 200 A in the USA):

$$Θ = Tamb + Δ T + K * {I}^{2}$$

ΔT being determined by design and typically being equal to 10° C., and K being a factor also determined by design and being such that, typically:

$$K = 0.025 °C . / {A}^{2}$$

By way of example, if a current of 60 A is passing through the meter 1, the difference between θ and Tamb will be:

$$( 10 + 0.025 * {60}^{2} ) = 19 °C ..$$

The application microcontroller 19b therefore measures the resistance of the thermistor 30, deduces the temperature θ therefrom and then deduces the ambient temperature Tamb from the temperature θ. The application microcontroller 19b can therefore estimate the ambient temperature Tamb in real time.

The application microcontroller 19b then detects a fire occurring outside the meter 1:
if smoke particles are present in the secondary part 8 of the casing 5;
and/or if the ambient temperature is above a predefined threshold.

The predefined threshold is, for example, 60° C.

The application microcontroller 19b triggers a first alarm when smoke particles are present. The application microcontroller 19b triggers a second alarm when the temperature is abnormally high.

If one or both of these alarms are triggered, the meter 1 detects a fire. The meter 1 then sends a corresponding alarm message to the HES (head end system) of the IS of the electricity supplier. The alarm message may be a first alarm message indicating an “abnormally high ambient temperature” or a second alarm message indicating the “presence of smoke”. The two alarm messages can be sent simultaneously.

As has been described, a fire will generally trigger at least one of the two alarms, if not both. The meter 1 will therefore signal, via the alarm message (s), that it has detected a probable fire in its surroundings before it is itself destroyed.

The sending and receipt of this or these alarm message(s) constitute conclusive proof that the meter 1 itself is not the cause of the fire and allow the meter 1 to be ruled out of the investigations. Indeed, if the fire originates from the meter 1 (or rather its incorrect installation a priori), the meter 1 will not immediately detect an abnormally high ambient temperature or smoke because it will be burning from the inside. The meter will therefore not have time to send an alarm message to the HES of the IS because it will be destroyed before it can do so. The fact that the HES has received at least one of the two alarm messages makes it possible to rule out the meter 1 as a cause in the event of a fire. It goes without saying that the invention is not limited to the described embodiment but covers any variant falling under the scope of the invention as defined by the claims.

The shape of the meter casing, and in particular of its main part and its secondary part, could be different from that described here.

This is also the case for the printed circuit. The components of the smoke detection device could be mounted on a printed circuit separate from that of the main part of the casing.

The smoke detection device could be different. The wavelength of the emitted light signals could be different. The components used could be different (for example a phototransistor instead of a photodiode). More generally, any type of technology can be used (e.g. a linear optical detector).

1. An electricity meter, comprising:
a casing comprising:
a main part; and
a secondary part provided with at least one first opening;
a smoke detection device positioned in the secondary part of the casing and arranged to detect smoke particles that have come from outside the meter and entered the secondary part through the at least one first opening; and
a processing unit positioned in the main part of the casing, connected to the smoke detection device and arranged to detect a fire occurring outside the meter if smoke particles are present in the secondary part of the casing.

2. The electricity meter according to claim 1, wherein the secondary part of the casing is located in a lower portion of the meter.

3. The electricity meter according to claim 1, further comprising a partition separating the main part and the secondary part of the casing, the at least one first opening being positioned in the region of a lower portion of the secondary part of the casing, the casing further comprising at least one second opening formed in the partition.

4. The electricity meter according to claim 1, wherein the processing unit and the smoke detection device are mounted on the same printed circuit, which extends in the main part and the secondary part of the casing.

5. The electricity meter according to claim 1, wherein the smoke detection device comprises a light emitter, arranged to emit light signals, and a light receiver, which are positioned in the secondary part of the casing such that:
when the secondary part does not contain smoke particles, the light receiver does not detect the light signals emitted by the light emitter; and
when the secondary part contains smoke particles, the light signals emitted by the light emitter are at least partly reflected by said smoke particles and detected by the light receiver.

6. The electricity meter according to claim 1, further comprising a temperature sensor,
wherein the processing unit is arranged to evaluate an ambient temperature outside the meter from temperature measurements produced by the temperature sensor, and
wherein the processing unit is arranged to detect a fire occurring outside the meter:
if smoke particles are present in the secondary part of the casing;
and/or if the ambient temperature is above a predefined threshold.

7. The electricity meter according to claim 6, wherein the processing unit is arranged to evaluate the ambient temperature from the temperature measurements and from measurements of a current supplied to an installation, the electrical energy consumption of which is measured by the electricity meter.

8. A method for detecting a fire and a cause of the fire, carried out in the processing unit of the meter according to claim 1, the method comprising detecting a fire occurring outside the meter if smoke particles are present in the secondary part of the casing.

9. The method according to claim 8, further comprising:
evaluating the ambient temperature outside the meter; and
detecting a fire occurring outside the meter if smoke particles are present in the secondary part of the casing and/or if the ambient temperature is above a predefined threshold.

10. A computer program comprising instructions that cause the processing unit to execute the method according to claim 8 for detecting a fire and the cause of the fire.

11. A non-transitory computer-readable storage medium on which the computer program according to claim 10 is stored.
